(19) United States
(12) Patent Application Publication
(10) Pub. No.: US 2007/0250214 A1
(43) Pub. Date: Oct. 25, 2007

(54) Method and apparatus for fuzzy logic control enhancing advanced process control performance

(76) Inventors: Shu-Yee Lee, Houston, TX (US); Nicole Garrett-Bennett, Seabrook, TX (US); Darrell G. Bond, Friendswood, TX (US)

Correspondence Address: M. Susan Spiering;c/o Celanese Ltd., IP Legal Dept., IZIP 701, P.O. Box 428, Bishop, TX, 78343, US

(21) Appl. No.: 11/407,610

(22) Filed: Apr. 20, 2006

(51) Int. Cl. G05B 21/00

(52) U.S. Cl. 700/266

(57) ABSTRACT

An apparatus and method for enhancing advanced process control (APC) performance based on fuzzy logic control (FLC) concept and methodology is described. The method and apparatus provide a systematic way to characterize/assess process operations (encompassing the manufacturing process, laboratory measurement systems, and control practices/results) automatically and then determine the best APC model update and feedback control strategies dynamically to cope with various control problems commonly observed in the polymer industry. Since the method is able to reach a single definite control output signal based upon vague, ambiguous, or imprecise input information, control issues that are difficult to quantify or model mathematically can now be addressed effectively and included as part of the APC control strategy. With the method, polymer manufactures can better use their existing off-line laboratory results for on-line APC controllers without resorting to costly on-line property measurements or inferential sensors.

### FIELD OF THE DISCLOSURE

The disclosure herein relates in general to the field of process control. More specifically, this disclosure concerns a method of controlling a polymer processes, such as (but is not restricted to) polyvinyl acetate process. Yet more specifically, the present disclosure relates to a method of process control wherein fuzzy logic is implemented for enhancing advanced process control performance.

### DESCRIPTION OF THE RELATED ART

Advanced Process Control (APC) has been widely used in chemical and polymer processes to optimize control of the manufacturing processes. APC is a multiple-input, multiple-output control technology where the effects of changing process inputs (i.e., manipulated variables and feed-forward variables) on process outputs (i.e., controlled variables) are captured in an embedded model. The system receives information about current process operating conditions, uses the model to predict the future response of the process (i.e. future controlled variable values), and then makes a sequence of future manipulated variable adjustments to control/optimize the process.

State of the art modeling techniques such as neural networks, principle component regression, and rigorous first principles models can be used for developing the APC model. The model is then updated regularly with real-time process measurements to ensure that its prediction values always track the measurement values. There are different ways to update the APC model, for example, parameter estimation, gain multiplier, and bias adjustment. Despite advances in the modeling and control technologies, it is still a great challenge to control polymer processes with APC technologies due mainly to lack of rapid and reliable on-line polymer property measurements.

In polymer manufacturing processes, polymer properties such as melt index, viscosity, density, etc. have to be carefully controlled to meet the end use requirements. However, measurement of the polymer properties during a polymerization reaction is extremely difficult, if not impossible. Process monitoring typically involves extracting samples of polymer from the process to perform conventional off-line measurements in a laboratory. In spite of great care taken to ensure reliable measurements by consistent sample preparation and analysis procedure, data generated by off-line laboratory instrumentation are susceptible to the inclusion of errors from a number of sources. For example, in a typical polyvinyl acetate process, there are potential sources of error in measuring polyvinyl acetate viscosity. These error sources include inconsistent representative sampling due to poor positioning of the sample point, sample preparation issues, and measurement instrument inaccuracies.

These and other errors, alone or in combination, can lead to unreliable laboratory values. Excessive variability associated with polyvinyl acetate viscosity measurement makes it extremely difficult to control the property. If unreliable laboratory values are used to update an APC model, what once was a good model would deteriorate rapidly. Consequently, the APC controller will make incorrect model predictions and generate erroneous control moves and not be able to control the process as designed.

Since laboratory samples are usually analyzed at a slower frequency than the process response time and may be several hours delayed, the laboratory results must be properly synchronized to the corresponding model predictions before being used to update the APC model. Polymer manufacturers typically need to make a wide variety of products, i.e., making one type of product (or grade) for a period of time and then changing operating conditions to make another product type (or grade). During the grade transition period, operating conditions and polymer properties change so dramatically and rapidly that it is essentially impossible to attain proper laboratory value synchronization.

Owing to the issues discussed above, off-line laboratory measurements are seldom directly usable for continuous closed-loop control (either APC technologies or conventional control strategies). Typically, polymer properties are controlled by adjusting process variables/conditions such as flows, temperatures, and pressures that can be measured directly. Human discretion of off-line laboratory results combined with process knowledge and operation experience is needed to establish the appropriate process variables/conditions. Control charts based on statistical process control (SPC) principles are frequently employed to tackle measurement error issues and to help determine required process adjustments.

One way to address the issues is to develop rapid and reliable on-line measurements that allow a fast and precise assessment of polymer properties and so enable responsive and effective polymerization feedback control. For example, Gui et al., in U.S. Pat. No. 6,635,224, disclose an on-line polymer monitoring apparatus that continuously collects polymer sample from the process, converts it into diluted polymer solution, passes the diluted solution through flow-through detectors, and measures polymer molecular weight, concentration, etc. Another example is the apparatus revealed by Docekal et al., in U.S. Pat. No. 4,327,587, where the rheological properties (e.g., complex viscosity) of monomers during polymerization are continuously measured based on ultrasonic oscillation method. More examples can be found in U.S. Pat. Nos. 6,945,094; 6,543,274; 6,427,525; and 5,158,720.

Another approach is to develop inferential models (or inferential sensors) that use real-time process measurements as inputs to predict polymer properties that cannot be readily or reliably measured. The inferential models can be built using neural networks, genetic programming, partial least squares, and first principles models. Treiber et. al. (U.S. Pat. No. 6,862,562) use a rigorous steady state model to compute instantaneous polymer properties (e.g., melt index and density) and then convert the instantaneous values to cumulative (bulk) polymer properties.

Instead of using a rigorous model, A. Buchelli (U.S. Pat. No. 5,065,336) describes a method using non-Newtonian fluid mechanics to compute polymer properties such as molecular weights and polydispersity. More examples can be found in U.S. Pat. Nos. 6,718,234 and 6,440,374.

Readily available process measurements (i.e., temperature, pressure, and flow) normally do not provide enough information for inferring polymer properties. A reliable inferential sensor typically requires some sophisticated on-line measurements such as compositions that closely relate to the properties of interest. For example, on-line gas chromatography (GC) analysis of the flash gas released from olefin polymerization processes is commonly used to infer/control the polymer's properties. Since the polymer's properties are actually related to compositions of the reaction mixture in the reactor (not the flash gas compositions), on-line measurement of the mixture's concentrations with Raman spectrometry has been disclosed to better control olefin polymerization processes (U.S. Pat. No. 6,723,804). Smith et al., in U.S. Pat. No. 5,650,722, disclose a nuclear magnetic resonance (NMR) system that measures physical characteristics (i.e., component curve equation constants derived from relaxation signal) of a polymer material in a real-time environment and then use those on-line measurements to predict the polymer's properties (e.g., melt index, density, etc.) based on an inferential model.

The conventional approaches are relatively time-consuming, costly, and sometimes ineffective. Thus a need exists for a process control system that can effectively utilize existing off-line laboratory results to automatically adjust APC model update and feedback control strategies to improve the controller's performance and robustness.

### BRIEF DESCRIPTION OF THE FIGURES

For detailed understanding of the present disclosure, references should be made to the following detailed description of an exemplary embodiment, taken in conjunction with the accompanying drawings:

FIG. 1 is a schematic illustration of a polymer production process;

FIG. 2 illustrates a flow chart of an embodiment of a method for determining control process parameters;

FIG. 3 illustrates a flow chart of an embodiment for determining an output control value using a fuzzy logic;

FIG. 4 illustrates a process model response curve according to one embodiment of an advanced process control program;

FIG. 5 illustrates a control chart having three zones for determining whether control action may be required;

FIG. 6 illustrates an example comparison of where the production process was operator controlled;

FIG. 7 illustrates system parameters monitored over several days for an embodiment of an advanced process control program;

FIG. 8 illustrates 20-day plant data covering steady state operations as well as dynamic grade transitions for a system controlled according to an embodiment of a fuzzy logic advanced process control program; and

FIG. 9 illustrates a machine for implementing an embodiment of an advanced process control program.

### DETAILED DESCRIPTION OF AN ILLUSTRATIVE EMBODIMENT

The present disclosure relates in general to the field of advanced process control (APC) of polymer processes, such as (but is not restricted to) polyvinyl acetate process, and more particularly to a method of automatically adjusting APC model update and feedback control strategies to improve the responsive performance an APC controller. Embodiments disclosed here address the above-discussed control issues by employing a fuzzy logic control (FLC) concept and methodology to enhance APC performance.

In one embodiment a computer readable medium is accessible to a processor for executing instructions contained in a computer program for a polymer production process. The computer program is embedded in the computer readable medium and includes an instruction to receive an input related to a polymer production process datum, an instruction to receive an input for determining a fuzzy logic value relating to the polymer production process datum, and an instruction to determine the polymer production process control value from the determined fuzzy logic value.

In another aspect of the embodiment, the input related to the polymer production process datum may be related to data quality, a transitional process state, a statistical process control parameter, or combinations thereof. The input for determining a fuzzy logic value relating to the polymer production process datum may be selected from at least two fuzzy variables. In still another aspect the computer program has instructions to combine a plurality of fuzzy logic values. The fuzzy logic values may be combined using a threshold criteria to determine the polymer production process control value. The threshold criteria may be selected from the group consisting of i) a maximum of the logic values, ii) a minimum of the logic values, iii) an average of the logic values, iv) a median of the logic values, v) a sum of the logic values, and vi) combinations of these values. In yet another aspect the polymer production process control value may be a bias to apply to a production process control model.

Another embodiment provides a method for polymer process control that includes acquiring polymer production process data, determining a first fuzzy logic value associated with data quality of the acquired process data, determining a second fuzzy logic value associated with a transitional process state of the acquired process data and combining the first and second fuzzy logic values to obtain a combined fuzzy logic value.

An aspect of the embodiment includes controlling a polymer process based on the combined fuzzy logic value. In another aspect the polymer process may be selected from a list consisting of stream flow rate, a ratio of a first stream flow rate to a second stream flow rate, process stream viscosity, and process temperature. A third fuzzy logic value may be determined from a statistical process control variable associated with the acquired process data. All the fuzzy logic values may be combined to determine a control parameter for the production process. Other aspects include validating the acquired process data and synchronizing the acquired process data with stored data.

An illustrative embodiment includes a method for determining a control parameter for an advance process controller. The method includes acquiring a process production datum, determining at least two fuzzy logic variables related to the process datum, determining a fuzzy logic value from the fuzzy logic variables and determining the control parameter from the fuzzy logic value.

In one aspect the production process datum may be selected from data quality, transitional process state and statistical process control. In another aspect the method includes determining the fuzzy logic value from fuzzy logic variables related to the production process datum, the datum associated with data quality, process state or statistical process control. Still another aspect includes combining a plurality of fuzzy logic values to determine the control parameter. Combining the plurality of fuzzy logic values may include using threshold criteria to determine the control parameter. The threshold criteria may be one of i) a maximum of the logic values, ii) a minimum of the logic values, iii) an average of the logic values, iv) a median of the logic values, v) a sum of the logic values, and vi) combinations of these values. Determining the fuzzy logic value may include selecting a transitional process state variable that may be a rapid transition, a slow transition or a steady state. Determining the fuzzy logic value may include selecting a statistical process control variable that could represent a stable zone, a warning zone, an action zone, or combinations thereof. Determining the fuzzy logic value may include selecting a data quality variable that may be a good quality or a poor quality.

At least one illustrative embodiment of the present disclosure includes a methodology that seamlessly integrates classic APC technology with FLC technology, including unconventional FLC technology. This integrated system can deliver precise APC performance with enhanced quality control that also has the ability to manage uncertainty. Moreover, based on the assessment of observed process operations, a single output signal can be generated for instructing the APC controller in updating its model and calculating control commands with offline laboratory values. By doing so, the APC controller is able to automatically and intelligently adjust its control strategy to cope with various complex control problems commonly observed in the polymer industry. In addition, SPC practices normally adopted by the industry may also be included as part of the APC control strategy.

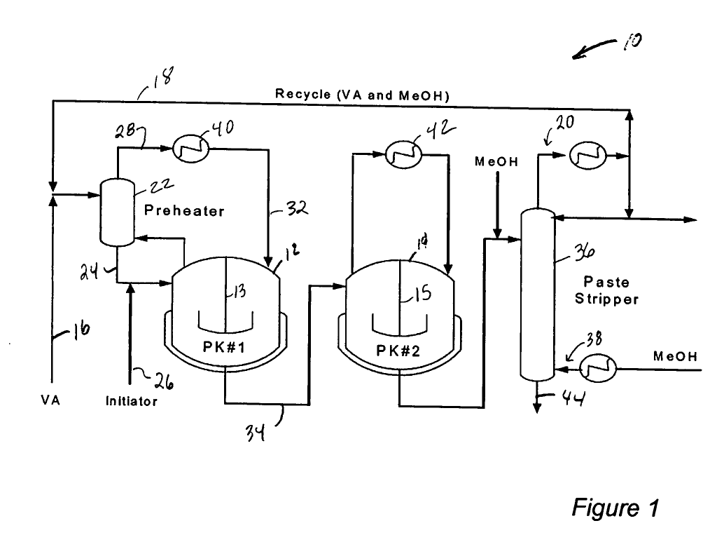

An example of a polyvinyl acetate process 10 is provided in FIG. 1 to illustrate an application of an embodiment of the system herein described. As shown, the polyvinyl acetate process comprises two stirred tank reactors (12, 14) and associated equipment for the manufacture of polyvinyl acetate. A vinyl acetate (VA) monomer stream 16 is mixed with a recycle stream 18 (containing vinyl acetate and methanol) from the paste stripper overhead 20 and fed to a preheater 22 where the cold liquid mixture is contacted with the hot methanol/vinyl acetate vapors rising from the first stirred tank reactor 12. The preheater bottoms liquid 24 and an initiator stream 26 combine and enter the first stirred tank reactor 12. The preheater overhead vapors 28 are sent to the first stirred tank reactor 12 reflux condenser 40 and return to the first stirred tank reactor 12 as a reflux liquid stream 32. The polymerization of vinyl acetate to polyvinyl acetate takes place in the two stirred tank reactors (12, 14). The first stirred tank reactor 12 bottoms liquid 34 stream is sent to the second stirred tank reactor 14 where additional polymerization takes place.

The paste stripper 36 is used to remove un-reacted vinyl acetate from the polyvinyl acetate solution. A methanol vapor stream 38 is introduced into the paste stripper 36 to strip vinyl acetate from the solution. The overhead fraction 20 from the paste stripper 36, consisting of methanol and vinyl acetate, can be directly recycled to the reactors (12, 14).

The polymerization reaction is heat generating, and the heat is removed by the preheater 22 and the two reflux condensers (40, 42). Polyvinyl acetate properties are affected by the residence time in the reactors (12, 14), VA monomer feed rate, MeOH solvent concentration, initiator concentration, and polymerization temperature.

APC technology combined with fuzzy logic techniques can be used to control and optimize the polyvinyl acetate process 10 of FIG. 1. A controller may be implemented for adjusting the following manipulated variables: i) total vinyl acetate feed rate; ii) ratio of initiator to vinyl acetate; iii) ratio of methanol to vinyl acetate; and iv) reactor pressures. The adjustments to the manipulated variables can be performed to maintain controlled variables (polyvinyl acetate properties) at the targets, examples of such controlled variables include: i) polyvinyl acetate rate; ii) polyvinyl acetate 15% viscosity; and iii) polyvinyl acetate solids weight percent (in the second reactor 14).

The controller also keeps many process variables, such as reflux condenser outlet temperatures, current flow to the reactor agitators (13, 15), etc. within certain high/low limits to ensure safe operation.

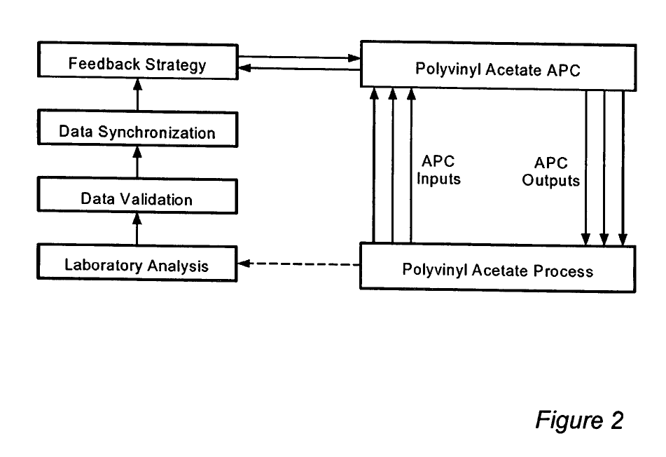

FIG. 2 is a schematic drawing of a polyvinyl acetate process having an APC system closely integrated with off-line laboratory measurements. The APC controller continuously receives current process information (i.e., APC inputs), calculates optimal control moves based on the embedded model, and then sends the optimal adjustments (i.e., APC outputs) back to the process for control and optimization.

Polyvinyl acetate samples are taken from the process and analyzed in the laboratory. The first step of the lab data analysis involves validating the laboratory value against some predetermined threshold criteria (e.g., maximum/minimum validity limit, maximum/minimum rate of change, maximum/minimum sample age, etc.). The value is identified as a valid value only if it lies between the maximum and minimum limits.

In the embodiment of FIG. 2, valid laboratory values are synchronized to the corresponding model prediction value based on the sample timestamp. Traditionally, a bias update is calculated as the offset between the model prediction and the laboratory value. This offset, or bias, is applied to the current model prediction value to ensure that the model prediction tracks the laboratory reported values. In some cases, the discrepancy between the prediction and the laboratory value can be expressed as ratio instead of offset, and different methods such as parameter estimation and gain multiplier are used to keep the APC model up-to-date.

The traditional approach has been found ineffective in addressing some important control issues commonly found in the polymer industry. For example, the “Data Validation” block in FIG. 2 only rejects laboratory results with enormous errors due to some gross mistake. Aberrant laboratory values caused by inherent measurement variation or minor mistake will easily pass the data validation test. Also, accurate laboratory data synchronization is essentially impossible especially during rapid grade transition, which would produce significant error in model update even if the laboratory measurement is absolutely correct. To work around the issues, a heavy filter is normally used to filter out the uncertainty/error, which in turn adversely makes the control action very sluggish. This would take a long time to correct an off-spec problem and produce much more off-spec materials.

To cope with the situation, a “Feedback Strategy” block is inserted between the “Data Synchronization” and “Polyvinyl Acetate APC” blocks, as illustrated in the embodiment of FIG. 2. The “Feedback Strategy” block, which is implemented based on the apparatus and method disclosed here, automatically and intelligently adjusts APC model update practice and feedback control strategy based on operation scenarios and measurement status.

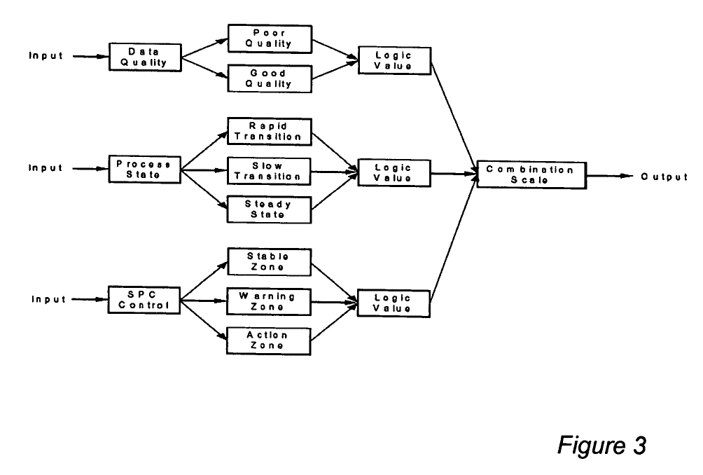

Illustrated in FIG. 3 is a block diagram of an embodiment of a method for obtaining a control output utilizing fuzzy logic computations. The output value of FIG. 3 can be used in conjunction with Equation 1 below for creating a bias value for a controller, such as an APC system. The control bias value is useful for making controls decisions and potential control actions. The output signal of Equation 1 (below) can also be implemented to govern APC model update practice and feedback control strategy.
Bias Used by APC=(100%−FIG. 3 output)*Bias Previously Used by APC+FIG. 3 output*Current Bias (Eqn. 1)

With regard to Equation 1, a 100% signal commands the APC to update its model and calculate its control moves solely based on the current laboratory value (which is an aggressive feedback control action) with an attempt to fully compensate for the control error. Of course, it is also the most sensitive to measurement variation or error. On the other hand, the lowest possible signal is 0%, which instructs the APC to ignore the laboratory value completely and make no control action at all.

In one embodiment using Equation 1, actual process samples (lab samples) are taken from an associated process. The time, amount, and location of these samples is not limited in scope and is determinable by those of skill in the art. The frequency of the lab sample may be dependent on the transition state of the particular process being monitored; this too can be determined by those skilled in the art without undue experimentation. The operation of Equation 1 may be performed each time a lab sample is obtained.

The value of the “Bias Used by APC” of Equation 1 is used to determine if adjustments to the process are necessary, and if so, what appropriate measures should be taken. The “current bias” represents the difference between the “model” data and the actual lab data. This difference can be in absolute form or a ratio. The model data (or target data) considered can be taken from an algorithm used to model the particular process under consideration. Table 1 below provides an illustrative example of successive operations of Equation 1. In this example, the target/model data is assumed to have a value of 100 and the lab sample data was given arbitrary values to simulate recorded data values taken from an actual process.

TABLE 1

| Run | Model/Target | Lab | Bias | Previous Bias | New Bias |
|---|---|---|---|---|---|
| 1 | 100 | 100 | 1 | 1 | — |
| 2 | 100 | 100 | 1 | 1 | 1 |
| 3 | 100 | 100 | 1.1 | 1 | 1.03 |
| 4 | 100 | 107 | 1.07 | 1.03 | 1.042 |

The input values to the logic chart of FIG. 3 comprise input parameters that may adequately portray the control problem at hand. In one illustrative embodiment, three input parameters are identified: (1) data quality, (2) process state, and (3) SPC control. Data quality relates to off-line and historical measurements, data synchronization, and error/variation comparisons of a current sample. Process state concerns include whether sample values are in a transient or steady state. SPC Control involves operation practices based on SPC control charts. Although FIG. 3 illustrates these three input variables for one logic flow implementation, an embodiment of the present method includes analysis of any single input variable and may optionally include combinations with at least one other input variable.

The combination of the three input parameters illustrated in FIG. 3 can be further processed into one of eight fuzzy variables using fuzzy logic. These fuzzy variables include; selecting either poor quality or good quality for the data quality; rapid transition, slow transition, or steady state for the process state; and/or stable zone, warning zone, or action zone for the SPC control. Classification of input parameters may be done in a very flexible way wherein each fuzzy variable is defined by trial-and-error. While the two of the three input variables, process state and SPC control, are illustrated with three fuzzy variables, it will be appreciated that only two are required by the process according to an embodiment of the method, and the number of fuzzy variables per input value may be determined with regard to particular process control applications.

Fuzzy logic values for each corresponding input value may be computed using rule-based structure and/or membership functions. The fuzzy logic values may range in magnitude from 0 up to 1. This step associates a weighting with each of the input parameter values, defines functional overlap between input parameter values, and ultimately determines a fuzzy logic value. For example, fuzzy logic value for “Data Quality” can be defined as simply as:

Poor Quality Fuzzy Logic Value=0 if Error %>X %: where X is an empirically derived value based on examples of an error magnitude that yielded poor quality data.

Fuzzy Logic Value=1−(Error %−Y %)/(X %−Y %) % if Y %<Error %<X % where Y is an empirically derived value based on examples of an error magnitude that yielded good quality data.

Good Quality Fuzzy Logic Value=1 if Error %<Y %.

Likewise, other fuzzy logic values can be defined by following the general trend summarized in the Table below. It is well within the capabilities of those skilled in the art to ascertain such fuzzy logic values without undue experimentation.

| | Fuzzy Logic Value | | |
|---|---|---|---|
| | Small | Medium | Large |
| Process State | Rapid Transition | Slow Transition | Steady State |
| SPC Control | Stable Zone | Warning Zone | Action Zone |

The fuzzy logic operations can be based on multi-valued logic principles and/or “if-then” rules. The user-defined fuzzy logic operations can be modified and adjusted easily to improve the system performance. For example, a “minimum” function that returns the smallest number in a set of values can be used to combine the above multiple fuzzy logic values into a single value.

Once the fuzzy logic values are combined into a single logic value (0 to 1), the value can be scaled and converted to the control command output signal (e.g., 0%˜100% in Equation 1) governing APC model update and control strategies.

As can be envisioned from the above steps, the resulting “Feedback Strategy” block may trigger the most aggressive feedback control action if the laboratory result is good quality, the laboratory sample is taken during steady state operation, and the laboratory result is outside the upper/lower control limits. On the other hand, relatively little feedback control action may be taken if the laboratory result is poor quality, the laboratory sample is taken during rapid grade transition, or the laboratory result is close to the control target. The present method can be easily extrapolated to other applications in the realm of APC, for example, dynamically adjusting APC tunings based on operating conditions.

In one aspect of assessing a logic value for data quality in accordance with the present disclosure, a laboratory measurement may be processed through the “Data Validation” and “Data Synchronization” blocks (see FIG. 2), once validated the laboratory value can then be processed within the a data quality detection algorithm of FIG. 3 to determine if the value is “Good Quality” or “Poor Quality”.

An example of a data quality determination method useful herein includes using two inferential models to predict a set of estimate values (e.g., 15% viscosity). The embedded APC model and an empirical model based on statistic analysis of historical data may be used simultaneously. The APC model used for determining data quality can be updated infrequently with off-line laboratory data if necessary. Data quality further involves calculating error by subtracting the model-based predictions (APC or other models) from the synchronized laboratory value. Statistical tests may be performed on the errors to determine if the laboratory value is “good quality” or “poor quality” based on the tested significance, e.g., the error smaller/greater than predetermined threshold values.

For good quality data the control system may be required to make corrective moves in the event of a laboratory value outside its control limits. The particular corrective moves will depend on the process system involved and the difference between the target and actual data. However, if the laboratory value happens to be “poor quality” at the time, little control action will be made based on the value.

Because it may be problematic to confidently achieve appropriate synchronization when a data sample is taken during a transient or dynamic state, the control values indicated may be given less weight, thereby leading to less emphasis when large control moves are indicated during these transitions.

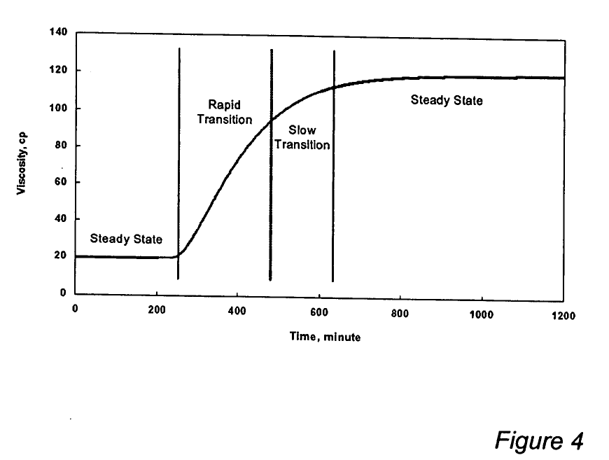

In one non-limiting example of implementation of the present method, FIG. 4 shows typical dynamic model response of the polyvinyl acetate viscosity during a grade transition from 20 centipoise to 120 centipoise. This represents the stream stripper bottoms stream 44 of FIG. 1. The process dynamics for this stream are dominated by the two reactors (12, 14), of which time constants are about 90 minutes. It takes approximately 700 minutes for the process to reach the steady state and about 150 minutes for the laboratory to complete a 15% viscosity measurement. A 20 minute error in either the sample time stamp or the model dynamic prediction can result in ˜0% error (Steady State) to as high as 25% error (Rapid Transition), depending on which state the sample is taken. In order to control the process dynamically, it is necessary to know whether the process is in a transient state or in a steady state so appropriate APC model update and feedback control strategies can be tailored.

As illustrated in FIG. 4, the process state is classified into three fuzzy variables, i.e., “Rapid Transition”, “Slow Transition”, and “Steady State”. The following steps can be used to automatically determine the process state. A reference trajectory (also referred to as a transition state path) is obtained from the APC. Reference trajectories are the desired control variable responses (e.g., polyvinyl acetate viscosity), which the APC controller attempts to produce in the process. The reference trajectories look very similar to the response curve in FIG. 4 in shape but have different times to steady state (as a function of the production rate).

Historical model prediction values of control variables of interest may be continuously collected during this time. Based on current process dynamics and reference trajectories, a proper period of historical data to perform statistical analysis is determined. The process state is then designated as “Rapid Transition”, “Slow Transition”, and “Steady State” based on the statistical test results. For example, the coefficient of variation has been found to work well for this particular purpose.

$$CoefficientofVariation = \frac{StandardDeviation }{Mean} \times 100$$

At the beginning of grade transition, the coefficient of variation rapidly increases. As the grade transition progresses with time, the coefficient gradually decreases.

Polymer manufacturers regularly resort to SPC control charts to tackle inherent process variability and measurement variation issues. The SPC practice is frequently lost during the evolution from conventional control strategies to APC technologies. The method disclosed here provides an optional way to include the SPC control practice as part of APC control strategy.

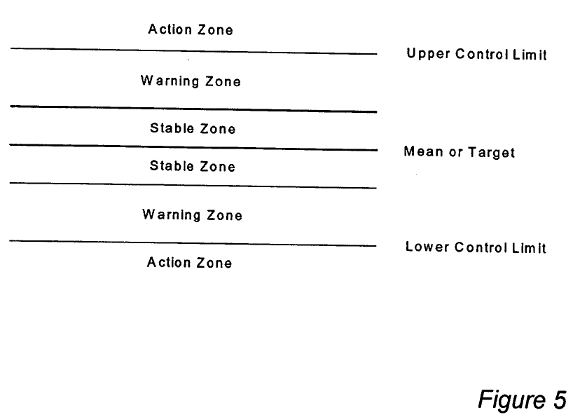

Assuming that for each polyvinyl acetate grade, there is a target 15% viscosity (i.e., mean or target) the objective of the APC controller is to keep the viscosity at that target. Based on statistics analysis, upper control limit and lower control limit can be established for a given grade. The upper/lower control limits are normally set at three standard deviations each side of the target. A control chart is shown in FIG. 5 having three zones wherein the required process control action depends on the zone in which the sample result falls. Likewise, the input parameter, SPC control, is classified into three corresponding fuzzy variables (stable zone, warning zone, or action zone).

In a stable zone, the process is considered to be “in statistical control” and actions/adjustments are unnecessary, indeed they may increase the amount of variability. Very little (or no) APC model update or control action is taken for data points in this zone.

In a warning zone, in accordance with common SPC practices, no control action should be taken unless the presence of unusual patterns is sensed, such as a succession of points that are above or below the mean. This kind of SPC practice can be easily implemented with the method disclosed here if desirable. For the case discussed here, conservative control action is always taken for any data point in this zone, provided the data points are good quality. Warning limits are typically set one to two standard deviations each side of the mean.

Concerning an action zone, data points in this zone suggest some action should be taken, which typically either investigates or, if appropriate, adjusts the operating conditions. In the case discussed here, the investigation part is accomplished by the data validation algorithm earlier described. If the data point turns out to be good quality, aggressive control moves will be made to fully compensate for the control error.

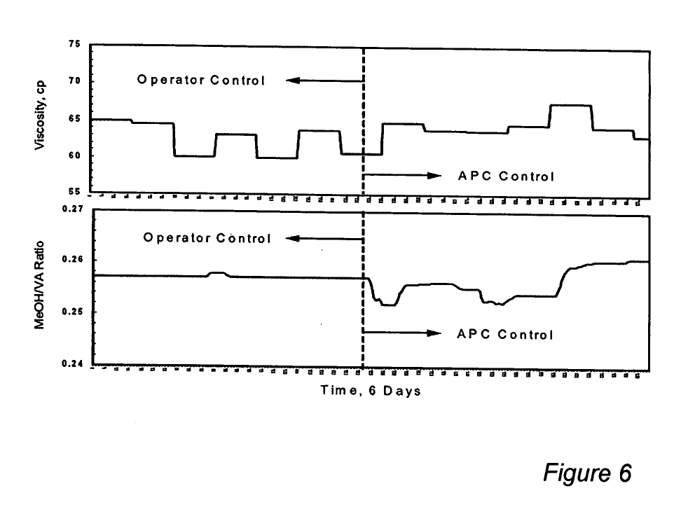

Examples of historical plant data are presented in FIGS. 6-8 to show the control results. As discussed earlier, APC is a multiple-input, multiple-output control technology that adjusts multiple manipulated variables simultaneously to control multiple controlled variables. However, for discussion and illustration purposes, only the primary manipulated variable (i.e., MeOH/VA Ratio) for polyvinyl acetate viscosity control is displayed here. Therefore, some of the manipulated variable adjustments in the following figures may not be very straightforward. The objective of the APC controller is to keep the viscosity at the target (i.e., setpoint control, not constraint control).

Data from a processing plant having the general process scheme of FIG. 1 were obtained. FIG. 6 illustrates data from a 6—day plant period during which the process was operator controlled for the first three days, followed by another three days with APC control with no enhancement by the apparatus and method disclosed here. The polyvinyl acetate operator and APC controller both adjusted MeOH/VA Ratio as the primary handle to control polyvinyl acetate viscosity at a given target. During this particular 6-day period, the process appeared to be “in statistical control” most of the time and the viscosity measurements were all good quality. A distinctive difference can be easily seen from FIG. 6—the operator barely adjusted the process conditions (based on SPC practices) whereas the APC controller made many responsive control moves. The controller tended to over-react to small measurement variation. If the process measurements were “true” values all the time, the responsive control action would be definitely desirable, as witnessed by a marginally better control performance with the APC during this particular period. Since process variability and measurement variation are inevitable, the responsive and indiscriminate control action can easily cause problems in the event of unreliable measurement values. In fact, off-spec materials were produced several times due to the APC control action.

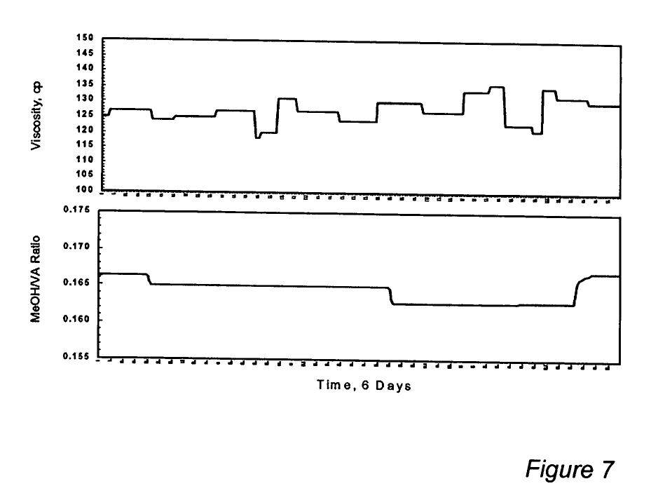

FIG. 7 shows APC performance enhanced by the apparatus and method disclosed here having FLC logic, using an illustrative application of an embodiment of a fuzzy logic advance process control program. For this particular 6-day period, the process appeared to be “in statistical control” most of the time. As can be seen, the controller did not necessarily make control moves in response to changes in the viscosity. Instead, the “Feedback Strategy” block in FIG. 2 evaluated the overall operation situation (i.e., the manufacturing process, laboratory measurement systems, and control practices/results) and then determined the best APC model update and feedback control strategies. Even though the viscosity control results may appear substantially similar with or without using the “Feedback Strategy” block, the present method and apparatus has significantly reduced unnecessary APC control moves. As a result, the controller is much more robust. The term “robust” when used in conjunction with process control typically means that the control is not sensitive to outside uncertainty factors. Since the apparatus and method disclosed here is based on FLC concept and methodology, heuristic rules based on process knowledge and operation experience can be easily incorporated as part of APC control strategy to improve overall control performance dramatically.

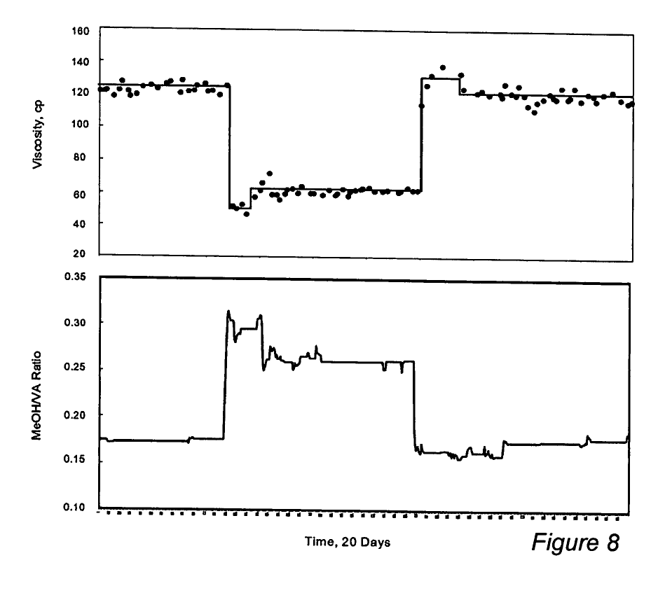

In yet another non-limiting example of implementation of the method herein described, superior and robust APC performance is illustrated in FIG. 8. This figure includes 20-day plant data covering steady state operations as well as dynamic grade transitions. During this period, the process was controlled by the APC and the only operator adjustment required involves changing the viscosity target, as indicated by the solid line in FIG. 8. The controller performed relatively well in spite of the presence of some aberrant, unreliable laboratory values, which seem to occur more frequently during grade transition. Good quality products with no off-spec were produced during this period. As can be seen from FIG. 8, operations overshot the viscosity target temporarily in the beginning of the grade transition to reduce transition times as well as help blend-off transition materials. This overshoot practice was adopted only after continuously and consistently observing the controller's superior performance. Approximately 30%˜40% reduction in transition times has been achieved.

FIGS. 7 and 8, i.e., Plant Automation Services' control product, or, Non Linear Control (NLC) were used to illustrate implementation of the present method. NLC is a nonlinear APC technology which is based on first-principles dynamic models. The method disclosed in the present invention can be applied to other nonlinear APC control technologies based on empirical neural network models as well. The present invention reveals the application of NLC to the polyvinyl acetate process resulting in significant benefits to the process.

FIGS. 7 and 8, i.e., Plant Automation Services' control product, or, Non Linear Control (NLC) were used to illustrate implementation of the present method. NLC is a nonlinear APC technology which is based on first-principles dynamic models. The method disclosed in the present invention can be applied to other nonlinear APC control technologies based on empirical neural network models as well. The present invention reveals the application of NLC to the polyvinyl acetate process resulting in significant benefits to the process.

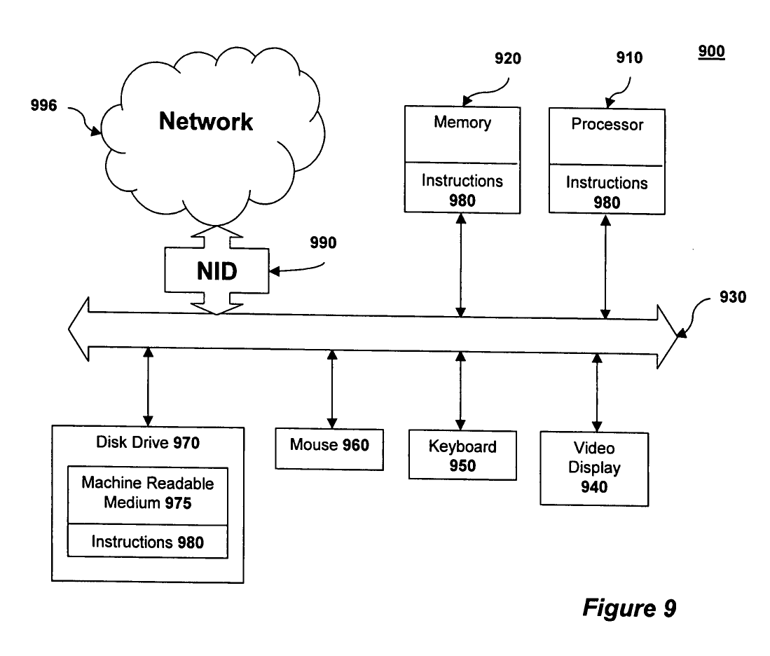

FIG. 9 is a schematic illustration of a machine, apparatus or device including a computer system 900. Executing instructions within the computer system may enable the machine to perform any one or more of the methodologies discussed herein. In one embodiment the machine may operate as a standalone device. In other embodiments, the machine may be connected using a network to other machines. Machines that are networked together may operate cooperatively in a server-client user network environment and further may enable a distributed processing environment. The machine may include a computer server, a client-user computer, a personal computer, a Personal Digital Assistant (PDA), a cellular, wireless or mobile telephone or device, a network router, switch or bridge, or any machine for executing a set of instructions and capable of communicating with other machines. Embodiments of the machine provide voice, video or data communication, and may communicate with other machines over a bus or communication network.

A machine, which may be computer system 900 includes a processor 910 and memory 920. Processor 910 and memory 920 communicate over a subsystem 930 (e.g., a computer bus) that transfers data or power between computer components inside a computer or between computers. A bus can logically connect several computer component peripherals over the same set of wires. Each bus may define a set of connectors to physically plug devices, cards or cables together. In some embodiments computer system 900 may include a video display unit 940. The computer system 900 may include one or more data input devices such as keyboard 950, a mouse or other cursor control device 960 that may be associated with a graphical user interface, a disk drive 970 or other memory storage unit, and a network interface device (NID) 990.

Disk drive 970 may include a machine-readable medium 975 with instructions or software 980. Instructions or software 980 may embody any of the methodologies or functions disclosed herein. The instructions 980 may also reside, completely or at least partially, within the memory 920 and/or within the processor 910. Embodiments of the computer system 900 may include software, firmware, and hardware implementations. Software implementations may include distributed processing, parallel processing, or virtual machine processing. Any instructions 980 or data associated with methods and functions disclosed herein may further be transmitted or received over a network 996 via the network interface device 990.

While the machine-readable medium 975 is shown in an example embodiment as a single medium, it will be appreciated that the term “machine-readable medium” includes single or multiple media including associated centralized or distributed databases, caches and servers that include one or more sets of instructions. The term “machine-readable medium” includes any media that are capable of storing, encoding or carrying a set of instructions for execution by a machine causing the machine to execute any illustrative embodiment. Accordingly, the illustrative embodiment includes recognized equivalents and successor media capable of storing software implementations.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. For example, the methodology disclosed herein can be easily used to resolve other control issues by those skilled in the area. Additional input parameters, such as production rate and product specifications, can be implemented. The fuzzy variables for these input parameters can be, for example, low rate/medium rate/high rate and low viscosity/medium viscosity/high viscosity. Moreover, APC tuning parameters, APC operating ranges, and APC models can be dynamically and intelligently adjusted by the method disclosed here. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “illustrative embodiment” merely for convenience and without intending to limit the scope of this application to any single invention or inventive concept. While specific embodiments have been disclosed herein it will be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Although the illustrative embodiment has been described with reference to several illustrative embodiments, it is understood that the words that have been used are words of description and illustration, rather than words of limitation. Changes may be made within the purview of the appended claims, as presently stated and as amended, without departing from the scope and spirit of the illustrative embodiment in its aspects. Although the illustrative embodiment has been described with reference to particular means, materials and embodiments, the invention is not intended to be limited to the particulars disclosed; rather, the invention extends to all functionally equivalent structures, methods, and uses such as are within the scope of the appended claims.

What is claimed is:

1. A computer readable medium accessible to a processor for executing instructions contained in a computer program for a polymer production process, the computer program embedded in the computer readable medium, the computer program comprising:
an instruction to receive an input related to a polymer production process datum;
an instruction to receive an input for determining a fuzzy logic value relating to the polymer production process datum;
an instruction to determine the polymer production process control value from the determined fuzzy logic value.

2. The computer readable medium of claim 1, wherein the input related to the polymer production process datum is at least one selected from the group consisting of i) data quality, ii) process state, iii) statistical process control, and iv) combinations thereof.

3. The computer readable medium of claim 1, wherein the input for determining a fuzzy logic value relating to the polymer production process datum is selected from at least two fuzzy variables.

4. The computer readable medium of claim 1, wherein the computer program further comprises an instruction to combine a plurality of fuzzy logic values.

5. The computer readable medium of claim 4, wherein the fuzzy logic values are combined using a threshold criteria to determine the polymer production process control value, the threshold criteria selected from the group consisting of i) a maximum of the logic values, ii) a minimum of the logic values, iii) an average of the logic values, iv) a median of the logic values, v) a sum of the logic values, and vi) combinations thereof.

6. The computer readable medium of claim 1, wherein the determined polymer production process control value is a bias to apply to a production process control model.

7. A method for polymer process control comprising:
acquiring polymer production process data;
determining a first fuzzy logic value associated with data quality of the acquired process data;
determining a second fuzzy logic value associated with a transitional process state of the acquired process data; and
combining the first and second fuzzy logic values to obtain a combined fuzzy logic value.

8. The method of claim 7 further comprising controlling a polymer process based on the combined fuzzy logic value.

9. The method of claim 8, wherein the polymer process is selected from a list consisting of stream flow rate, a ratio of a first stream flow rate to a second stream flow rate, process stream viscosity, and process temperature.

10. The method of claim 7 further comprising determining third fuzzy logic value from a statistical process control variable associated with the acquired process data.

11. The method of claim 7 further comprising validating the acquired process data.

12. The method of claim 7 further comprising synchronizing the acquired process data with stored data.

13. A method of controlling a process, comprising:
(a) acquiring process data;
(b) determining a fuzzy logic variable related to the process data;
(c) determining a fuzzy logic value from the fuzzy logic variable; and
(d) communicating the fuzzy logic value to an advanced process controller.

14. The method of claim 13 further comprising determining another fuzzy logic variable related to the process data.

15. The method of claim 13 wherein said fuzzy logic value is a bias value used by the advanced process controller.

16. The method of claim 15 wherein the control bias value is used by the advanced process controller for making process control decisions.

17. The method of claim 15 wherein the control bias value is used by the advanced process controller for making process control actions.

18. The method of claim 13 wherein the process data is selected from the group consisting of i) data quality, ii) process state, iii) statistical process control, and iv) combinations thereof.

19. The method of claim 13 further comprising determining the fuzzy logic value from fuzzy logic variables related to process data selected from the group consisting of i) data quality, ii) process state, iii) statistical process control, and iv) combinations thereof.

20. The method of claim 13 further comprising combining a plurality of fuzzy logic values to determine the control parameter.

21. The method of claim 13 further comprising combining a plurality of fuzzy logic values using a threshold criteria to determine the control parameter, the threshold criteria selected from the group consisting of i) a maximum of the logic values, ii) a minimum of the logic values, iii) an average of the logic values, iv) a median of the logic values, v) a sum of the logic values, and vi) combinations thereof.

22. The method of claim 13 wherein determining the fizzy logic value further comprises selecting a process state variable that is at least one selected from the list consisting of i) rapid transition, ii) slow transition, iii) steady state, and iv) combinations thereof.

23. The method of claim 13 wherein determining the fuzzy logic value further comprises selecting a statistical process control variable that is at least one selected from the list consisting of i) a stable zone, ii) a warning zone, iii) an action zone, and iv) combinations thereof.

24. The method of claim 13 wherein determining the fuzzy logic value further comprises selecting a data quality variable that is at least one selected from i) a good quality and ii) a poor quality.
